(19) United States
(12) Patent Application Publication
(10) Pub. No.: US 2011/0108556 A1
(43) Pub. Date: May 12, 2011

(54) BROWNIE PAN WITH EDGES

(75) Inventor: Mark Levie, Ross, CA (US)

(73) Assignee: Mark Levie, Ross, CA (US)

(21) Appl. No.: 12/940,402

(22) Filed: Nov. 5, 2010

Related U.S. Application Data
(60) Provisional application No. 61/258,878, filed on Nov. 6, 2009.

(51) Int. Cl. A47J 37/01

(52) U.S. Cl. 220/573.1

(57) ABSTRACT

A brownie pan system includes a pan, at least one separation wall, and means for holding the at least one separation wall in place in the pan. The pan has a bottom, side walls and end walls. The end walls are positioned at longitudinal ends of the pan. The at least one separation wall is dimensioned to seat in the pan longitudinally so that the bottom edge of the separation wall sits in the vicinity of the bottom of the pan.

### CROSS-REFERENCE TO RELATED APPLICATION

This application claims priority to U.S. Provisional Application No. 61/258,878, filed on Nov. 6, 2009, the disclosure of which is incorporated herein by reference in its entirety.

### FIELD

This technology relates to a brownie pan having edge-browning capability. More particularly, the technology relates to edge-browning inserts that are removable from the baking pan in order to allow for differently sized brownies and ease of cleaning

### BACKGROUND

Edge-browning brownie pans are known. Those currently on the market do not have flexibility in sizing brownies. One pan has a serpentine pattern that provides for a constant width brownie. Other edge-browning pans have individual spaces for each brownie such that all four sides of each brownie are browned. These types of pans are more costly to manufacture and harder to clean.

### BRIEF DESCRIPTION OF THE DRAWING FIGURES

FIG. 1 is an exploded perspective view of an example brownie pan system;

FIG. 2 is a perspective view of an example brownie pan system similar to that shown in FIG. 1;

FIG. 3 is a perspective view of an alternative example brownie pan system; and

FIG. 4 is an expanded perspective view of another alternative example brownie pan system.

### DETAILED DESCRIPTION

The example brownie pan system 10 provides a brownie pan 12 that has separation walls 14 that provide for additional browning of the edges of the brownies. The separation walls 14 provide more linear edge area, which yields more chewy edge volume. A chewy edge is often desirable to the consumer and the present system 10 allows a user to control the amount of chewy edge that is created. The user may control the amount of edge area versus non-edge (or cake brownie) area based upon how many separation walls 14 are utilized at a given time.

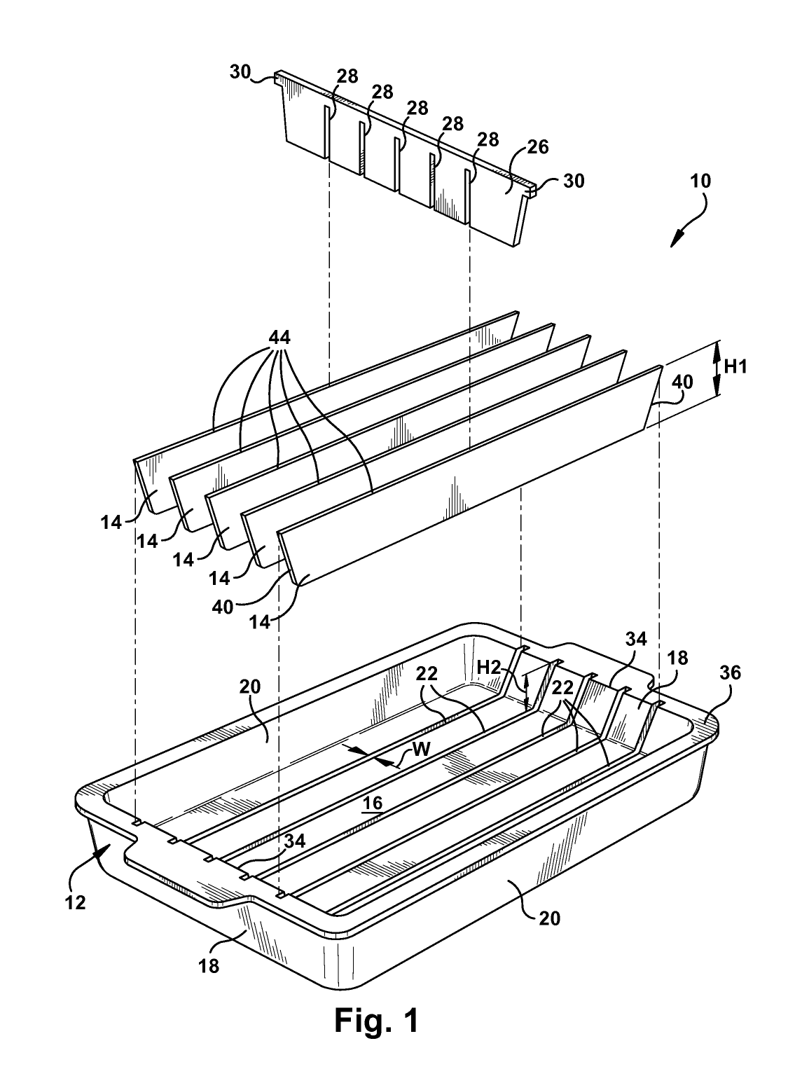

One example brownie pan system 10 is shown in FIG. 1 and includes a pan 12 having a bottom 16 and four sides. The pan 12 shown is rectangular and has two end walls 18 and two side walls 20. The end walls 18 are positioned at the longitudinal ends of the pan 12. The pan 12 includes five channels or troughs 22 that extend along the full length of the bottom 16 of the pan 12 and up the end walls 18 of the pan 12. The channels 22 are sized to accept separation walls 14, which are also shown in FIG. 1. The separation walls 14 are used to provide additional browning to the edges of the brownies and are sized to seat in the channels 22. The separation walls 14 and pan 12 are configured to brown the edges of the brownie that are positioned in proximity to the respective surfaces 14, 18, 20.

In the example shown in FIG. 1, the channels 22 are spaced about 2 inches apart, although different spacing may also be utilized. One or more separation wall 14 may be used at a time, which makes the system 10 flexible in terms of the sizing of the brownies. If two walls 14 are used instead of all five walls, wider brownies would be provided for, as well as one narrower row of brownies. If the user prefers some brownies with “cake-like” edges, then the wider brownies could be cut to provide the cake-like edge while the brownies in the narrower row would have more chewy edge. This provides greater flexibility to the user, who can decide in advance how many cake-like edges are desired and how many chewy edges are desired.

A slicer 26 is also provided that includes grooves 28 for seating over each of the separation walls 14. The slicer 26 has a grip 30 at each end for assisting in slicing and allows the user to slice across the entire width of the pan 12 at one time when the separation walls 14 are positioned in the pan 12. The slicer 26 could also be used without the separation walls 14 and may or may not have grooves 28.

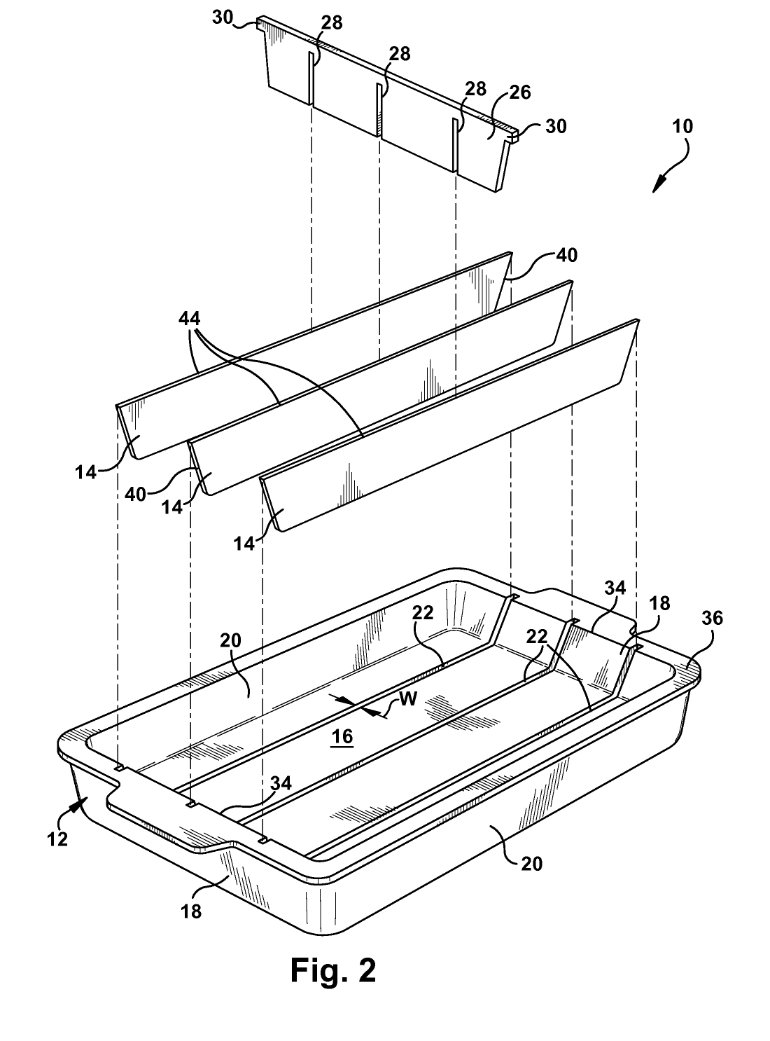

FIG. 2 shows an example brownie pan system 10 that is similar to that shown in FIG. 1, but that has only three longitudinal channels 22 rather than the five presented in FIG. 1. The three channels 22 may be evenly spaced apart or may have different spacings. In this example, assuming a brownie pan 12 having dimensions of approximately 9 inches wide by 13 inches long, the longitudinal channels 22 and separation walls 14 could be spaced about 2.25 inches apart to make evenly sized receptacles for receiving brownie batter. The slicer 26 can be used to slice the brownies in whatever size is desired. If some cake-like brownie edges are desired along with some brownies having greater chewy edges, one separation wall 14 could be utilized so that both types of brownies could be baked.

In this example, the slicer 26 has three grooves 28 for seating over the separation walls 14. The slicer 26 may be used to slice any width of brownie and a cake-like edge will be created where the slicer 26 slices the brownies. If desired, the slicer 26 can be inserted during baking to provide additional chewy edges and then removed to be utilized for slicing after the brownies have been baked. In this regard, multiple slicers 26 could be used for the same purpose.

The longitudinal channels 22 may have a width that is sized to accept the bottom of the separation walls 14 therein. The channels 22 may be sized so that the separation walls 14 seat snugly therein or seat comfortably therein. The channels 22 have a depth that is large enough to accept the bottom of the separation walls 14 therein and the total height H1 of the separation walls 14 is sized so that the bottom of the separation wall 14 seats adjacent the bottom of the longitudinal channel 22 when the separation wall 14 is seated in the channel 22. Thus, the height H1 of the separation wall 14 is approximately equal to the height H2 of the channel 22 from the top of the end wall 18 to the bottom of the channel 22.

The slicer 26 is shown as having grips 30 that are formed along with the slicer 26 as an integral part thereof. Alternatively, the slicer 26 could have separately formed grips 30 that are attached to the slicer 26 in any known manner (not shown). The slicer 26 does not necessarily need to be included with the system 10 since the brownies could be sliced with a standard knife either while the separation walls 14 are in place or after the separation walls 14 are removed.

The separation walls 14 may be about 2 inches tall and may be spaced about two inches apart. As discussed above, other spacings may be utilized and the spacing will also depend upon the size of the pan 12. A traditional size for a brownie pan 12 is approximately 13 inches long by 9 inches wide by two inches tall. Other sizes may also be utilized, such as an 8×8 inch square pan, a 9×9 inch square pan, a round pan, or an oval pan, among other shapes. Deeper pans 12 may be used if desired and the separation walls 14 and slicer 26 would be sized accordingly.

There may be provided a draft angle A on the side 20 and end 18 walls of the baking pan 12 such that the walls extend outwardly at an angle A relative to the bottom 16 of the pan 12. Thus, the walls need not be perpendicular to the bottom 16 of the baking pan 12. A radius R may also be provided at the bottom edge of each wall in order to assist in removing the brownies from the baking pan 12. The longitudinal channel 22 width is wide enough to allow for placement and removal of the separation walls 14 while holding securely when in place along the full length of the pan 12.

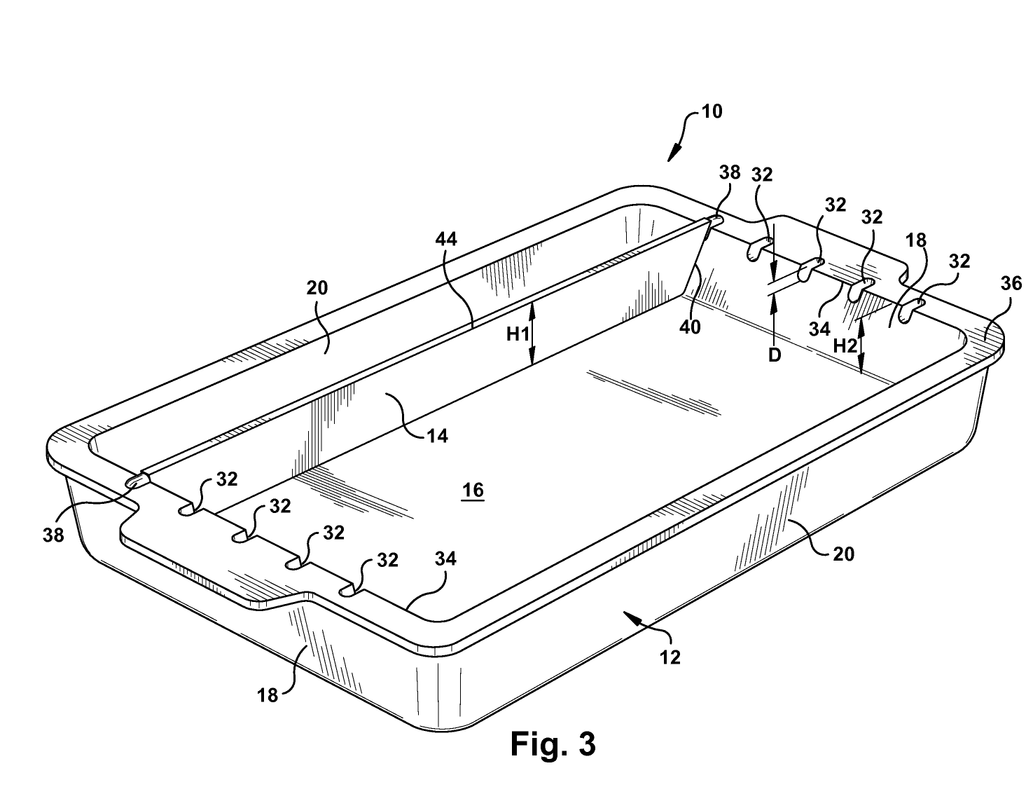

FIG. 3 is an alternative example of the brownie pan system 10. In this example, the longitudinal channels 22 are replaced by grooves 32 that are provided at each end wall 18 of the pan 12 at the top edge 34 of each end wall 18. The side 20 and end 18 walls of the baking pan 12 have a rim 36 that extends therearound. The rim 36 may be parallel to the bottom 16 of the pan 12. The grooves 32 are defined in the rim 36 and the end walls 18. In this example, the grooves 32 do not extend to the bottom 16 of the pan 12. Five grooves 32 in total are shown spaced approximately 1½ to 2 inches apart, although any number of grooves 32 may be utilized and at different spacings. Separation walls 14 are utilized to provide edge surfaces for browning the brownie batter during baking

One separation wall 14 is shown in FIG. 3, but more than one separation wall 14 could be utilized, if desired. For example, a brownie pan system 10 could be provided with three or five total separation walls 14, or one for each groove 32, and then the user may decide how many walls 14 to use at any given time. The separation walls 14 include outwardly extending pegs 38 at the top of either end thereof. The pegs 38 seat in the grooves 32 defined in the end walls 18 such that the separation walls 14 sit flush against the end walls 18 and the bottom 16 of the baking pan 12. The walls 18, 20 of the pan 12 may taper at a draft angle A, as discussed above in connection with FIGS. 1 and 2.

The end 40 of each separation walls 14 tapers to match the taper of the corresponding end wall 18 of the baking pan 12. The separation walls 14 are dimensioned so that they sit flush against the bottom 16 of the pan 12. The grooves 32 in the end walls 18 have a depth D that is sufficient for accepting the pegs 38. A slicer 26 may be provided, if desired, as discussed above. Grips 30 may be positioned on the separation wall 14, as desired, or the pegs 38 could be used as grips 30.

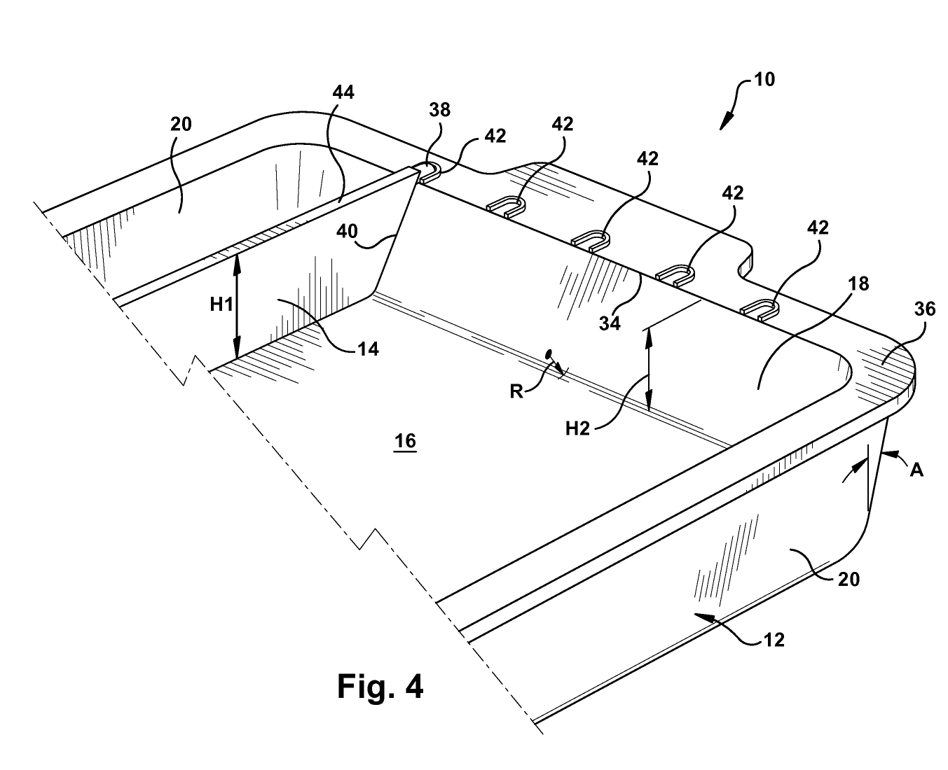

FIG. 4 is an alternative example of the brownie pan system 10 shown in FIG. 3. Instead of using grooves 32, as shown in FIG. 3, the brownie pan 12 of FIG. 4 utilizes U-shaped holders 42 that are sized and dimensioned to hold the pegs 38 of the separation walls 14. The pan 12 shown in FIG. 4 has a rim 36 that extends outwardly from the side 20 and end 18 walls and the U-shaped holders 42 are coupled to the rim 36. The U-shaped holders 42 are spaced approximately 1½ to 2 inches apart for a 9 inch wide by 13 inches long pan 12, although other spacings may also be utilized. The separation walls 14 are sized and dimensioned so that the separation walls 14 seat flush against the end walls 18 and the bottom 16 of the pan 12. The U-shaped holders 42 may be integrally fabricated with the rim 36 of the pan 12, or could be added via welding or other attachment mechanism as known by those of skill in the art.

Any type of material may be utilized with the example brownie pan system 10 that is known to those of skill in the art, including coated metal. For example, a durable, non-stick coating and heavy gauge cast aluminum construction may be used. Teflon coatings (polytetraflouroethylene or PTFE) or other coatings may be utilized to provide non-stick performance. Aluminized steel, steel, or other materials may also be utilized for the pan 12 and separation walls 14, among other materials as known by those of skill in the art. Alternatively, plastics or silicone materials that withstand heat and provide browning may be utilized. The pan 12 may be the same as or a different material from the separation walls 14, if desired. The slicer 26 can be the same material as or different from the material of the pan 12 and the separation walls 14.

Any size pan 12 may be utilized. For example, the pan 12 may be rectangular, square, round, or oval. When a square pan is utilized, two opposing walls are selected as the end walls 18 and the other two opposing walls are selected as side walls 20. When a round pan is utilized, the pan is divided into quarters with opposite quarters representing the end walls 18 and the other two quarters representing the side walls 20. When the pan is round, the separation walls 14 may have different lengths to accommodate the shape of the pan. With an oval pan, the longitudinal ends are considered the end walls 18, with the side walls being the other walls. When the pan is oval, the separation walls 14 may have different lengths to accommodate the shape of the pan.

The top edge 44 of the separation walls 14 may be substantially flush with the rim 36 or top edge 34 of the end wall 18 of the pan 12. Alternatively, the top edge 44 of the separation walls 14 may extend above or below the rim 36 of the pan 12. In use, the user decides how many separation walls 14 to utilize with the pan 12. The user then prepares a batter and pours it into the pan 12. The separation walls 14 may be inserted before or after the batter is poured into the pan 12. The batter is then baked until done. Then the user may utilize a slicer 26 having grooves 28 and slice the brownies while the separation walls 14 are still in place. The user could instead cut the brownies with a knife (not shown). The separation walls 14 may then be removed and the brownies removed from the pan 12. Alternatively, the user could remove the separation walls 14 first and use either a slicer 26 or a knife (not shown) to cut the brownies.

While the above description is in the context of baking brownies, any type of bakery may utilize the baking pan 12 described above. Any type of cake-like batter may be utilized. It is anticipated that other materials may also be prepared in the baking pan 12, other than cake-like batter.

The term “substantially” is used herein as a term of estimation.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A brownie pan system comprising:
a pan having a bottom, side walls and end walls, with the end walls being positioned at longitudinal ends of the pan;
at least one separation wall dimensioned to seat in the pan longitudinally so that the bottom edge of the separation wall sits in the vicinity of the bottom of the pan; and
means for holding the at least one separation wall in place in the pan.

2. The system of claim 1, wherein the means for holding the at least one separation wall is a channel that extends along the length of the pan, a pair of grooves that are defined on opposing end walls of the pan, or a pair of U-shaped holders that are defined on opposing end walls of the pan.

3. The system of claim 1, wherein the pan is one of rectangular, square, round, or oval.

4. The system of claim 2, wherein the pan has a rim that extends around the perimeter of the side and end walls, with the rim having a surface that is substantially parallel to the bottom of the pan; and
when the at least one means for holding is a longitudinal channel, multiple channels are provided;
when the means for holding is a pair of opposed grooves, multiple opposed grooves are provided, or
when the means for holding is a pair of opposed U-shaped holders, multiple opposed U-shaped holders are provided, with the U-shaped holders being raised portions of material defined on the rim of the pan.

5. The system of claim 2, wherein when the holding means is a longitudinal channel, the separation wall includes grips at either end thereof, with the grips being utilized to lower the separation wall into the channel or to remove the separation wall from the channel.

6. The system of claim 2, wherein when the holding means is a pair of opposed grooves or a pair of opposed U-shaped holders, the separation wall includes a peg positioned at either end thereof, said pegs being sized to seat in the grooves or U-shaped holders.

7. The system of claim 1, wherein the pan has angled side and end walls that extend outwardly from the bottom of the pan.

8. The system of claim 1, wherein the pan has a radiused edge positioned around the perimeter of the bottom of the pan.

9. The system of claim 2, wherein the means for holding provides three locations for the separation walls.

10. The system of claim 1, further comprising a slicer configured to slice in a direction that is perpendicular to the longitudinal direction of the pan.

11. The system of claim 10, wherein the slicer has slots for positioning over the separation walls so that the slicer may be used when the separation walls are in positioned in the pan.

12. The system of claim 1, wherein the separation walls seat snugly against bottom of the pan.

13. The system of claim 1, wherein the separation walls seat snugly against the end walls of the pan.

14. The system of claim 1, wherein the separation walls seat snugly against the end walls and the bottom of the pan.

15. The system of claim 1, wherein the pan is about 9 inches wide by about 13 inches long by about 2 inches deep and the at least one separation wall is about 2 inches tall.

16. The system of claim 1, wherein five separation walls are provided along with five means for holding, with the means for holding being spaced about every 1½ inches along the end walls of the pan.

17. The system of claim 1, wherein three separation walls are provided along with three means for holding, with the means for holding being spaced about every 2.25 inches along the end walls of the pan.

18. The system of claim 1, further comprising a rim that extends around the side and end walls of the pan, with the rim being substantially parallel to the bottom of the pan and with the means for holding being grooves that are defined in both the rim and along part of the height of the end walls.

19. The system of claim 2, wherein the at least one longitudinal channel has a depth to allow the at least one separation wall to seat therein.

20. The system of claim 1, wherein the pan further comprises handles for carrying the pan, with the handles being positioned at the end walls of the pan.
